(19) United States
(12) Patent Application Publication
(10) Pub. No.: US 2013/0260759 A1
(43) Pub. Date: Oct. 3, 2013

(54) METHOD FOR HANDOVER IN VEHICULAR COMMUNICATIONS AND ON-BOARD EQUIPMENT USING THE SAME

(71) Applicant: ELECTRONICS AND TELECOMMUNICATIONS RESEARCH IN, Daejeon-city (KR)

(72) Inventors: Hyun-Kyun CHOI, Daejeon (KR); Dong-Kyoo Kim, Chungcheongnam-do (KR); Jung-Sook Kim, Daejeon (KR); Dong-Yong Kwak, Daejeon (KR); Dong-Sun Lim, Seoul (KR)

(73) Assignee: Electronics and Telecommunications Research Institute, Daejeon-city (KR)

(21) Appl. No.: 13/690,545

(22) Filed: Nov. 30, 2012

(30) Foreign Application Priority Data
Apr. 3, 2012 (KR) 10-2012-0034569

(51) Int. Cl. H04W 36/24

(52) U.S. Cl. CPC H04W 36/24
USPC 455/436

(57) ABSTRACT

Disclosed herein are a method for handover in vehicular communications and On-Board Equipment (OBE) using the same. In the method for handover in vehicular communications, OBE performs a handover from first Road-Side Equipment (RSE) to second RSE. The OBE receives beacon frames from the first RSE and the second RSE. The first average value of a received signal strength indication corresponding to the beacon frame received from the first RSE and the second average value of a received signal strength indication corresponding to the beacon frame received from the second RSE are calculated. The first cumulative gradient of the first average value and the second cumulative gradient of the second average value are calculated. The handover from the first RSE to the second RSE is performed based on the first average value, the second average value, the first gradient, and the second gradient.

### CROSS REFERENCE TO RELATED APPLICATION

This application claims the benefit of Korean Patent Application No. 10-2012-0034569, filed on Apr. 3, 2012, which is hereby incorporated by reference in its entirety into this application.

### BACKGROUND OF THE INVENTION

1. Technical Field

The present invention relates generally to a method for handover in vehicular communications and On-Board Equipment (OBE) using the same and, more particularly, to a handover method that is capable of supporting high-speed handover in wireless communications using a plurality of service channels without interrupting service in such a manner that OBE communicates with a plurality of pieces of Road-Side Equipment (RSE).

2. Description of the Related Art

In the field of vehicular communications, traffic can be more safely and efficiently managed using an Intelligent Transportation System (hereinafter referred to as the “ITS”).

Currently, a technology for communication between vehicles and between a vehicle and an infrastructure using Dedicated Short Range Communication (DSRC) corresponding to a communication method for the ITS and related services have been developed. Furthermore, with regard to the Wireless Access in Vehicular Environments (hereinafter referred to as the “WAVE”) technology, the standardization of IEEE802.11p and IEEE1609 has been completed or is currently under way.

The WAVE technology is a wireless communication technology that enables packet data to be exchanged between vehicles or between a vehicle and an infrastructure within a short period of time in an environment in which a vehicle is moving at high speed. The WAVE technology was developed by adapting the IEEE 802.11a/g wireless LAN technology to a vehicle environment.

The environment to which the WAVE technology is applied includes OBE mounted on a vehicle and a plurality of pieces of RSE installed on the side of a road. The WAVE technology standard employs the 5.9 GHz dedicated frequency band, and includes IEEE 802.11p and IEEE 1609.x. Here, IEEE 802.11p includes a physical layer and a MAC layer that are used to perform wireless transmission, and IEEE 1609.x includes an upper multi-channel layer, a networking layer, an authentication security layer and an application service layer that are installed over IEEE 802.11p.

IEEE 1609.4 relates to a multi-channel operation, and uses a single control channel (CCH) and a plurality of service channels IEEE 802.11p MAC layer uses the same protocol as the IEEE 802.11 wireless LAN standard, but provides a control channel for safe message transmission and a service channel for traffic message transmission in order to reduce the packet latency upon transmitting a safe message and employs a multi-channel switching method. A service provider provides notification of services being provided using a WAVE Service Announcement (WSA) message that is periodically sent via the control channel, and the user of a vehicle periodically may monitor the control channel and use a plurality of service channels.

Currently, the communication technologies that are being used in the ITS domestically and overseas include wireless LAN, DSRC and WAVE technologies. These technologies provide the services of the collection and provision of traffic information in the central area of a metropolis, and provide safety and convenience on expressways. As described above, the vehicular communications environments require the continuous communication of the ITS because the high-speed mobility of a vehicle should be taken into consideration and service should be provided in a wide area, and require high communication reliability because the communications are directly related to safety. For this reason, a soft handover technology is required to handle the movement of a vehicle, but the wireless LAN and WAVE technologies do not provide handover functionality.

Conventional technologies for providing handovers in the vehicular communications environment include Korean Patent Application No. 10-2010-0055494 invention entitled “Apparatus and Method for Allocating Channel Using Wireless Access in Vehicle Environment,” which discloses a technology for allocating a channel that is required for a terminal to perform a handover from existing RSE to another RSE. In the technology disclosed in Korean Patent Application No. 10-2010-0055494, RSE is selected by comparing the average received signal strength indications of WSA frames received from two adjacent pieces of RSE via a CCH channel and a channel corresponding to the provider ID of the highest priority one of the services that are provided by the selected RSE is selected.

The conventional technologies for providing handovers in the vehicular communications environment further include Korean Patent Application No. 10-2010-0120696 entitled “Apparatus and Method for Supporting Handovers in Vehicular Communications,” which discloses an apparatus and method for providing a handover technology that enables the communication of a vehicle with the side of a road in the vehicular communications environment. In the technology disclosed in Korean Patent Application No. 10-2010-0120696, when a vehicle requests a handover, information about the handover of the vehicle is transferred to RSE located in the direction in which the vehicle proceeds via a WAVE handover control unit, and the RSE which has received the information allocates a channel access priority to the vehicle which requested the handover. Furthermore, in the technology disclosed in Korean Patent Application No. 10-2010-0120696, reliable media access can be achieved using a WAVE Point Coordination Function (WPCF) channel access method upon handover on a contention free basis, and the time it takes to support a handover is estimated and a subsequent RSE to which a handover will be performed is also selected by adopting a dedicated handover controller, thereby reducing the scanning delay time and also providing continuous connectivity.

However, the above-described conventional technologies (Korean Patent Application Nos. 10-2010-0055494 and 10-2010-0120696) are problematic in that they do not take into consideration a variety of methods of selecting RSE to perform a handover.

### SUMMARY OF THE INVENTION

Accordingly, the present invention has been made keeping in mind the above problems occurring in the prior art, and an object of the present invention is to provide a handover method that is capable of supporting high-speed handover in wireless communications using a plurality of service channels without interrupting service in such a manner that OBE communicates with a plurality of pieces of RSE.

In order to accomplish the above object, the present invention provides a method for handover in vehicular communications, in which On-Board Equipment (OBE) performs a handover from first Road-Side Equipment (RSE) to second RSE, the first RSE and the second RSE being successively located on a side of a road, the method including receiving, by the OBE, beacon frames from the first RSE and the second RSE; calculating a first average value of a received signal strength indication corresponding to the beacon frame received from the first RSE, and a second average value of a received signal strength indication corresponding to the beacon frame received from the second RSE; calculating a first cumulative gradient of the first average value and a second cumulative gradient of the second average value; and performing the handover from the first RSE to the second RSE based on the first average value, the second average value, the first gradient, and the second gradient.

The performing the handover may be performed if the first gradient is negative, the second gradient is positive, the second average value is larger than a minimum received signal strength indication, and the second average value is larger than the first average value.

The performing the handover may include transferring a registration release message to the first RSE; and transferring a handover request message to the second RSE.

The handover request message may include the source Internet Protocol (IP) address information and Media Access Control (MAC) address information of the OBE.

In order to accomplish the above object, the present invention provides OBE for performing a handover from first RSE to second RSE, the first RSE and the second RSE being successively located on a side of a road, the OBE including a reception unit configured to receive beacon frames from the first RSE and the second RSE; a computation unit configured to calculate a first average value of a received signal strength indication corresponding to the beacon frame received from the first RSE, and a second average value of a received signal strength indication corresponding to the beacon frame received from the second RSE, and to calculate a first cumulative gradient of the first average value and a second cumulative gradient of the second average value; and a performance unit configured to perform the handover from the first RSE to the second RSE based on the first average value, the second average value, the first gradient, and the second gradient.

The performance unit may perform the handover if the first gradient is negative, the second gradient is positive, the second average value is larger than a minimum received signal strength indication, and the second average value is larger than the first average value.

The performance unit may transfer a registration release message to the first RSE, and transfer a handover request message to the second RSE.

The handover request message may include the source IP address information and MAC address information of the OBE.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an environment to which a method for handover in vehicular communications according to an embodiment of the present invention is applied;

FIG. 2 is a diagram illustrating an example in which a plurality of super frames is used according to an embodiment of the present invention;

FIG. 3 is a diagram showing the structure of a super frame according to an embodiment of the present invention;

FIG. 4 is a diagram schematically showing the process of performing a handover in vehicular communications according to an embodiment of the present invention;

FIG. 5 is a diagram showing the configuration of OBE according to an embodiment of the present invention; and

FIG. 6 is a flowchart showing a method of performing a handover in vehicular communications according to an embodiment of the present invention.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted from the following. The embodiments of the present invention are provided in order to fully describe the present invention to a person having ordinary skill in the art. Accordingly, the shapes, sizes, etc. of elements in the drawings may be exaggerated to make the description clear.

A method for handover in vehicular communications and on-board equipment using the same according to embodiments of the present invention will be described in detail below with reference to the accompanying drawings.

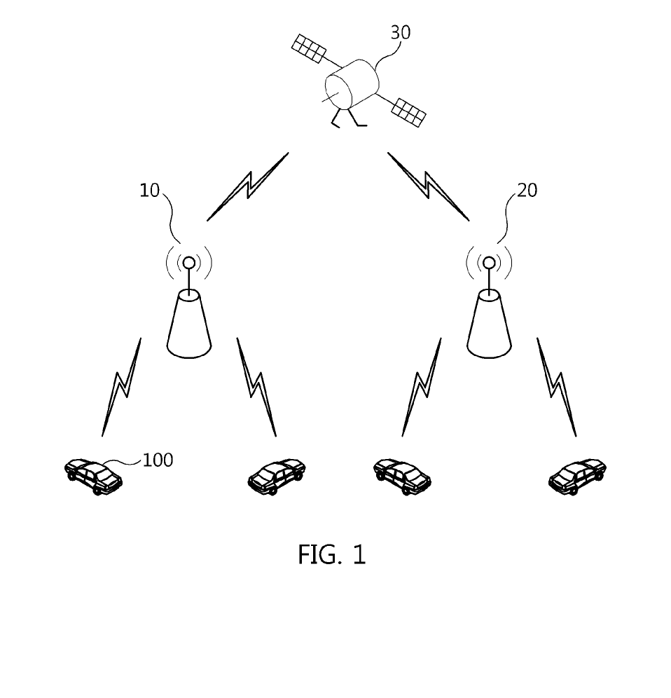

FIG. 1 is a diagram schematically showing an environment to which a method for handover in vehicular communications according to an embodiment of the present invention is applied.

Referring to FIG. 1, the environment to which the method for handover in vehicular communications is applied includes a plurality of pieces of RSE 10 and 20 and a plurality of pieces of OBE 100.

The plurality of pieces of RSE 10 and 20 and the plurality of pieces of OBE 100 should perform time synchronization.

The plurality of pieces of RSE 10 and 20 are synchronized with the 1 Pulse Per Second (PPS) signals of a GPS receiver or GNSS receiver 30. For example, when GPS signals are not desirably received as in a tunnel or in the central area of a metropolis, time errors are minimized using the accurate crystal oscillators of the RSE themselves.

The plurality of pieces of OBE 100 perform time synchronization using the time information of beacon frames that are periodically sent by the plurality of pieces of RSE 10 and 20. For this purpose, a beacon frame includes time stamp information.

Furthermore, the OBE 100 may select the target of a handover, that is, RSE, and register corresponding services via beacon frames that are received from the plurality of pieces of RSE 10 and 20.

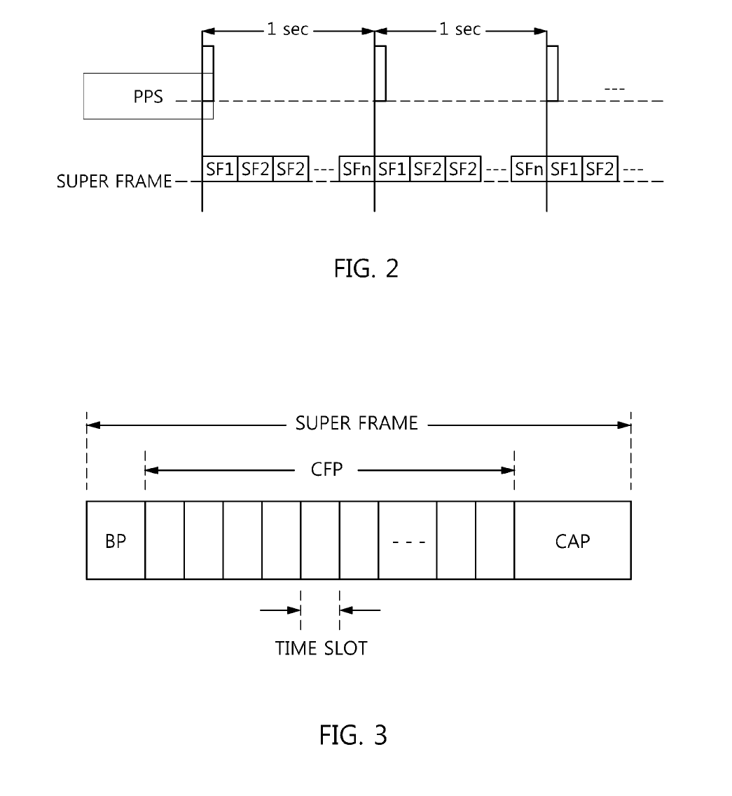

Next, an example in which a plurality of super frames is used will be described in detail with reference to FIG. 2.

FIG. 2 is a diagram illustrating an example in which a plurality of super frames is used according to an embodiment of the present invention.

First, RSE is synchronized with a one PPS signal of the GPS receiver or GNSS receiver 30, and the plurality of pieces of OBE 100 is synchronized with a beacon frame of the RSE. As shown in FIG. 2, a plurality of super frames SF1˜SFn is used in one second. A beacon frame is sent in the first period of each super frame.

Referring to FIG. 2, the number of super frames used in one second corresponds to the execution time of a determination algorithm that sets the target of a handover, that is, RSE.

Next, the structure of each super frame will be described in detail below with reference to FIG. 3.

FIG. 3 is a diagram showing the structure of a super frame according to an embodiment of the present invention.

First, the super frame operates using a time slot-based Time Division Multiple Access (TDMA).

Referring to FIG. 3, the super frame (SF) includes a beacon period (hereinafter referred to as the “BP”), a contention free period (hereinafter referred to as the “CFP”), and a contention access period (hereinafter referred to as the “CAP”).

The BP is located in the front part of the super frame, and is a period during which the beacon frame is sent.

The CFP is located subsequent to the BP, and is a contention free period during which an exclusive time slot remains allocated to OBE that was registered with RSE.

The CAP is a period that corresponds to OBE that is not registered with predetermined RSE.

The beacon frame that is sent via the BP according to an embodiment of the present invention is a frame that is sent over a common channel so that all vehicles within a set region can receive it. The beacon frame is an element that is required to select RSE and set a service channel upon performing a handover. Accordingly, the BP of each piece of RSE uses a common channel, and the CFP and the CAP, other than the BP, use different service channels in order to prevent interference with adjacent RSE.

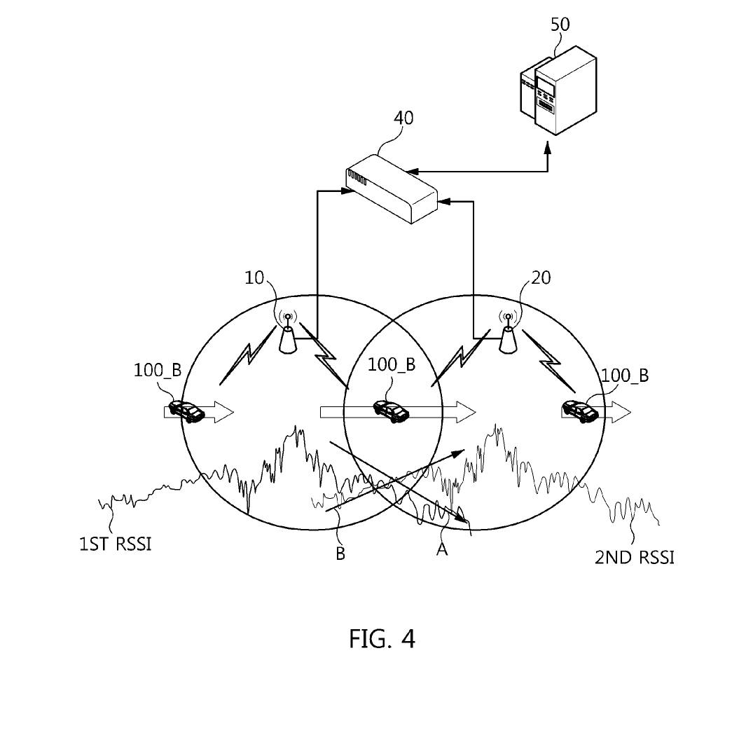

Next, the process of performing handover in vehicular communications will be described in detail with reference to FIG. 4.

FIG. 4 is a diagram schematically showing the process of performing handover in vehicular communications according to an embodiment of the present invention drawing.

Referring to FIG. 4, it is assumed that, for example, there are two pieces of RSE 10 and 20 adjacent to a location of a vehicle.

First, a vehicle 100_A was registered with first RSE 10. Next, a vehicle 100_B performs handover when it passes through a point at which it can receive beacon frames from the first RSE 10 and the second RSE 20 at the same time. Thereafter, when the vehicle 100_C moves out of a region corresponding to the first RSE 10, it terminates the connection with the corresponding first RSE 10 and is registered with the second RSE 20.

A router/switch 40 is responsible for connecting the first RSE 10 and the second RSE 20 to each other and connecting with the server 50. Here, the server 50 provides services to the OBE 100.

In a high-speed handover process according to an embodiment of the present invention, the BP that enables a beacon frame, via which information required to select the target of a handover (that is, RSE) or to set a service channel is sent by each piece of RSE, to be received at the same time should use a common channel. Furthermore, in the high-speed handover process, RSE receives a request for a handover from OBE 100, and sends an additional message used to reestablish a path in response to the request for a handover to the router/switch 40. Here, the additional message includes the source IP address information and source MAC address information of the OBE 100.

When the router/switch 40 receives the additional message, it deletes routing information related to the previous RSE, and updates routing information using new RSE.

Referring to FIG. 4, the first and second received signal strength indications are the received signal strength indications of beacon frames received from the first RSE 10 and the second RSE 20 by the OBE 100. Here, the arrows A and B of FIG. 4 indicate the gradients of variations in the received signal strength indications of the respective beacon frames once a handover has been done.

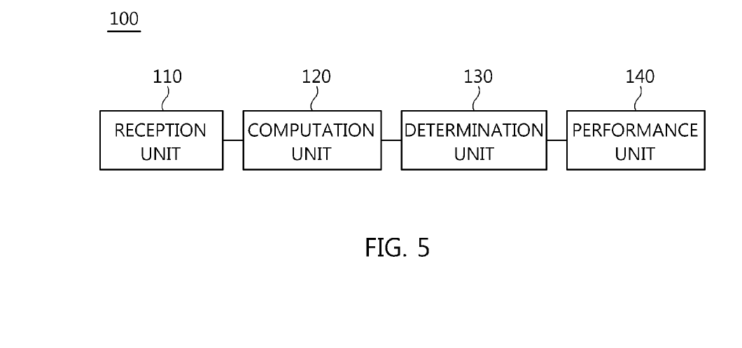

Next, the configuration of the OBE 100 that performs a handover, as shown in FIG. 4, will be described in detail with reference to FIG. 5.

FIG. 5 is a diagram showing the configuration of OBE according to an embodiment of the present invention.

First, the OBE 100 according to the embodiment of the present invention may receive beacon frames during a BP, and determines RSE which is located adjacent to itself and to which a handover must be made. In this case, the OBE 100 may select RSE based on the Received Signal Strength Indication (hereinafter referred to as the “RSSI”) of the beacon frames. The criteria for selecting RSE include the average RSSI values of respective beacon frames, gradient values each indicative of an increase or a decrease in the cumulative value of each average RSSI value, and the minimum RSSIs.

Since the measured RSSI value of each beacon frame varies from moment to moment, it is difficult to determine which RSE has the highest beacon frame RSSI using the value of a single beacon frame. Accordingly, the average RSSI value of each beacon frame is used as a criterion for selecting RSE according to an embodiment of the present invention.

Referring to FIG. 5, the OBE 100 includes a reception unit 110, a computation unit 120, a determination unit 130, and a performance unit 140.

The reception unit 110 receives respective beacon frames from at least two pieces of RSE. Here, the at least two pieces of RSE include the first RSE 10 currently corresponding to the OBE 100 and the target of a handover of the OBE 100, that is, the second RSE 20.

The computation unit 120 calculates the average RSSI value of each of the beacon frames that are received by the reception unit 110, and the cumulative gradient of the average RSSI value.

The determination unit 130 determines whether the first RSSI value of the beacon frame received from the first RSE 10 from which service is being currently received is decreasing (first gradient==“−”) and whether the second RSSI value of the beacon frame corresponding to the second RSE 20 is increasing (second gradient==“+”). Furthermore, the determination unit 130 determines whether the second average RSSI value of the beacon frame corresponding to the second RSE 20 has become larger than the minimum RSSI and the first average RSSI value of the beacon frames corresponding to the first RSE 10.

The performance unit 140, in a first case in which, as a result of the comparison by the determination unit 130, the first RSSI value of the beacon frame received from the first RSE 10 from which service is being currently received is decreasing and the second RSSI value of the beacon frame corresponding to the second RSE 20 is increasing and in a second case in which the second average RSSI value of the beacon frame corresponding to the second RSE 20 has become larger than the minimum RSSI and the first average RSSI value of the beacon frames corresponding to the first RSE 10, releases a connection to the first RSE 10 and performs a handover to the second RSE 20. At this time, the performance unit 140 transfers a handover request message to the second RSE 20. Here, the handover request message includes the source IP address information and source MAC address information of the OBE 100. Thereafter, the second RSE 20 transfers the handover request message to the router/switch 40.

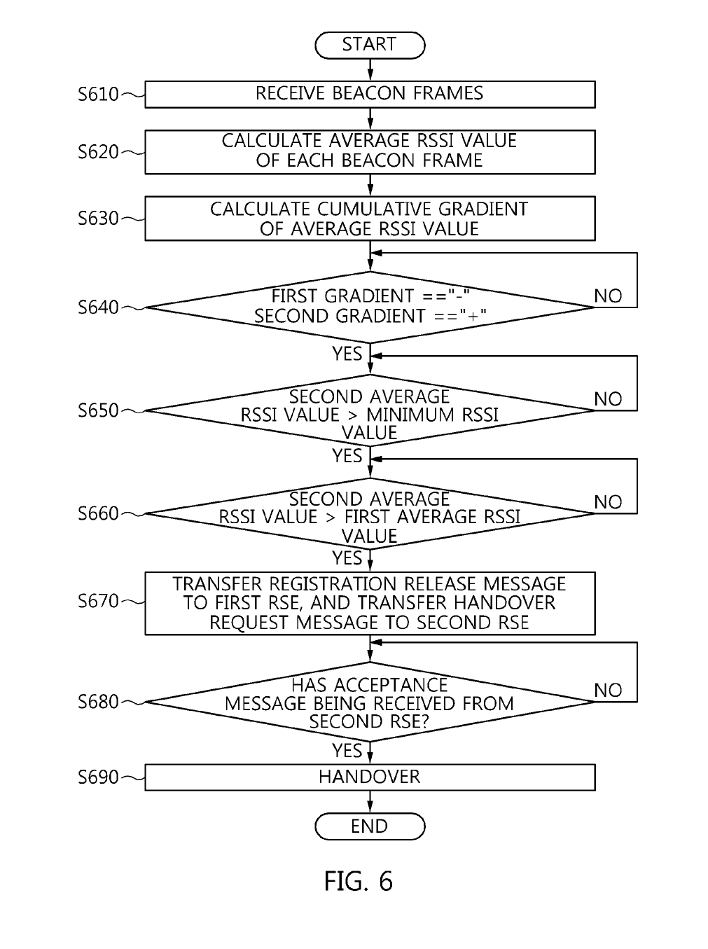

Next, a method by which the OBE 100 performs handover in vehicular communications will be described in detail with reference to FIG. 6.

FIG. 6 is a flowchart showing a method of performing handover in vehicular communications according to an embodiment of the present invention.

Referring to FIG. 6, the OBE 100 receives beacon frames from at least two pieces of RSE at S610. Here, the at least two pieces of RSE include the first RSE 10 currently corresponding to the OBE 100 and the target of the handover of the OBE 100, that is, the second RSE 20.

The OBE 100 calculates the average RSSI value of each of the beacon frames at step S620, and the cumulative gradient of the average RSSI value at step S630.

The OBE 100 determines whether the first RSSI value of the beacon frame received from the first RSE 10 from which service is being currently received is decreasing (first gradient==“−”) and whether the second RSSI value of the beacon frame corresponding to the second RSE 20 is increasing (second gradient==“+”) at step S640.

The OBE 100, if the first RSSI value is decreasing (first gradient==“−”; “A” of FIG. 4) and the second RSSI value is increasing (second gradient=“+”; “B” of FIG. 4), determines whether the second average RSSI value of the beacon frame corresponding to the second RSE 20 is larger than the minimum RSSI at step S650.

The OBE 100, if the second average RSSI value is larger than the minimum RSSI, determines whether the second average RSSI value is larger than the first average RSSI value of the beacon frame corresponding to the first RSE 10 at step S660.

The OBE 100, if the second average RSSI value is larger than the first average RSSI value, transfers a registration release message to the first RSE 10 and transfers a handover request message to the second RSE 20 at step S670.

The OBE 100 determines whether an acceptance message corresponding to the handover request message has been received from the second RSE 20 at step S680.

When the OBE 100 receives the acceptance message from the second RSE 20, it performs handover to the second RSE 20.

As described above, the present invention has the advantage of preventing an interruption in a service in wireless communications using a plurality of service channels in such a manner that the OBE communicates with the plurality of pieces of RSE that are successively located on the side of a road.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for handover in vehicular communications, in which On-Board Equipment (OBE) performs a handover from first Road-Side Equipment (RSE) to second RSE, the first RSE and the second RSE being successively located on a side of a road, the method comprising:
receiving, by the OBE, beacon frames from the first RSE and the second RSE;
calculating a first average value of a received signal strength indication corresponding to the beacon frame received from the first RSE, and a second average value of a received signal strength indication corresponding to the beacon frame received from the second RSE;
calculating a first cumulative gradient of the first average value and a second cumulative gradient of the second average value; and
performing the handover from the first RSE to the second RSE based on the first average value, the second average value, the first gradient, and the second gradient.

2. The method of claim 1, wherein the performing the handover is performed if the first gradient is negative, the second gradient is positive, the second average value is larger than a minimum received signal strength indication, and the second average value is larger than the first average value.

3. The method of claim 1, wherein the performing the handover comprises:
transferring a registration release message to the first RSE; and
transferring a handover request message to the second RSE.

4. The method of claim 3, wherein the handover request message includes source Internet Protocol (IP) address information and Media Access Control (MAC) address information of the OBE.

5. OBE for performing a handover from first RSE to second RSE, the first RSE and the second RSE being successively located on a side of a road, the OBE comprising:
a reception unit configured to receive beacon frames from the first RSE and the second RSE;
a computation unit configured to calculate a first average value of a received signal strength indication corresponding to the beacon frame received from the first RSE, and a second average value of a received signal strength indication corresponding to the beacon frame received from the second RSE, and to calculate a first cumulative gradient of the first average value and a second cumulative gradient of the second average value; and
a performance unit configured to perform the handover from the first RSE to the second RSE based on the first average value, the second average value, the first gradient, and the second gradient.

6. The OBE of claim 5, wherein the performance unit performs the handover if the first gradient is negative, the second gradient is positive, the second average value is larger than a minimum received signal strength indication, and the second average value is larger than the first average value.

7. The OBE of claim 5, wherein the performance unit transfers a registration release message to the first RSE, and transfers a handover request message to the second RSE.

8. The OBE of claim 7, wherein the handover request message includes source IP address information and MAC address information of the OBE.
